(19) United States
(12) Patent Application Publication
(10) Pub. No.: US 2019/0386755 A1
(43) Pub. Date: Dec. 19, 2019

(54) RADIO COMMUNICATION DEVICE, CALIBRATION METHOD

(71) Applicant: Fujitsu Limited, Kawasaki-shi (JP)

(72) Inventor: Shinichiro KOBAYASHI, Yokohama (JP)

(73) Assignee: Fujitsu Limited, Kawasaki-shi (JP)

(21) Appl. No.: 16/406,821

(22) Filed: May 8, 2019

(30) Foreign Application Priority Data
Jun. 13, 2018 (JP) 2018-113090

(51) Int. Cl. H04B 17/21; H01Q 3/26

(52) U.S. Cl. CPC H04B 17/21; H01Q 3/2611; H01Q 3/267

(57) ABSTRACT

A radio communicating device includes: a plurality of analog circuits being respectively configured to be associated with any of a plurality of antenna elements; and a processor configured to execute a generating process for generating calibration signals, the calibration signals being calibration signals equal in number to the plurality of antenna elements and being configured to cancel each other out when synthesized, execute a synthesizing process for synthesizing the calibration signals with the respective streams of the plurality of antenna elements, and execute a calculating process for calculating an equalizer coefficient based on the stream and a first feedback signal, the first feedback signal being a stream feedback signal fed back from each of the plurality of analog circuits, the equalizer coefficient being a coefficient for removing a phase rotation occurring in each of the plurality of analog circuits.

### CROSS-REFERENCE TO RELATED APPLICATION

This application is based upon and claims the benefit of priority of the prior Japanese Patent Application No. 2018-113090, filed on Jun. 13, 2018, the entire contents of which are incorporated herein by reference.

### FIELD

The embodiment discussed herein is related to a radio communication device and a calibration method.

### BACKGROUND

Calibration between a plurality of antenna elements is performed in beam forming that forms a beam by providing a phase difference to streams transmitted from a plurality of antenna elements, respectively. For example, analog circuits for the respective antenna elements, the analog circuits including a power amplifier and a band-pass filter or the like, give the streams respective different phase rotations. Thus, calibration is performed which makes the phase rotations in the analog circuits for the respective antenna elements uniform.

The calibration may be performed using transmission signals when the signals are transmitted from the antenna elements. In this case, however, whether or not the calibration may be performed depends on the presence or absence of transmission. Therefore, in order to perform the calibration stably, it is preferable to generate a known calibration signal, input the calibration signal to the analog circuits for the respective antenna elements, feed back the signals output from the analog circuits, and estimate the phase rotations in the analog circuits.

A signal in a same frequency band as the frequency band of main signals transmitted from the respective antenna elements may be used as the calibration signal. When the calibration signal is inserted into the streams during the transmission of the main signals, interference with the main signals occurs. Accordingly, in a time division duplex (TDD) system that may switch transmission and reception on a time-division basis, the calibration may be performed in a gap time during which neither of transmission and reception is performed, for example.

Examples of the related art include Japanese Laid-open Patent Publication No. 2016-152508 and Japanese Laid-open Patent Publication No. 2016-116199.

### SUMMARY

According to an aspect of the embodiment, a radio communication device includes: a plurality of analog circuits, each of the plurality of analog circuits being configured to be associated with one of a plurality of antenna elements, subject a stream of the associated antenna element to analog processing, and transmit the stream from the associated antenna element; and a processor configured to execute a generating process that includes generating calibration signals, the calibration signals being calibration signals equal in number to the plurality of antenna elements and being configured to cancel each other out when synthesized, execute a synthesizing process that includes synthesizing the calibration signals with the respective streams of the plurality of antenna elements, and execute a calculating process that includes calculating an equalizer coefficient based on the stream and a first feedback signal, the first feedback signal being a stream feedback signal fed back from each of the plurality of analog circuits, the equalizer coefficient being a coefficient for removing a phase rotation occurring in each of the plurality of analog circuits.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a radio communication system according to one embodiment;

FIG. 2 is a block diagram illustrating a configuration of a radio communicating device according to the one embodiment;

FIG. 3 is a block diagram illustrating a configuration of an equalizer section according to the one embodiment;

FIG. 4 is a block diagram illustrating a configuration of a coefficient calculating section according to the one embodiment;

FIG. 5 is a flowchart illustrating calibration operation according to the one embodiment;

FIGS. 6A to 6C are diagrams illustrating concrete examples of CAL signals; and

FIGS. 7A to 7D are diagrams illustrating concrete examples of transitions of streams.

### DESCRIPTION OF EMBODIMENT

However, using signals in a high-frequency band for radio communication has recently been considered. It is conceivable that when frequency is increased, unit times for switching between transmission and reception, such as slots or the like, are shortened. As a result, gap times allowing calibration are shortened, and the calibration is not completed during the gap times.

Accordingly, the level of a calibration signal may be decreased to reduce interference with a main signal even when calibration is performed during the transmission of the main signal. However, when the level of the calibration signal is decreased, convergence of a coefficient obtained by the calibration takes time, and an accurate coefficient is not calculated.

The disclosed technology has been made in view of such points, and it is an object of the disclosed technology to provide a radio communicating device and a calibration method that may perform calibration between a plurality of antenna elements even during signal transmission.

An embodiment of a radio communicating device and a calibration method disclosed in the present application will hereinafter be described in detail with reference to the drawings. It is to be noted that the present technology is not limited by the present embodiment.

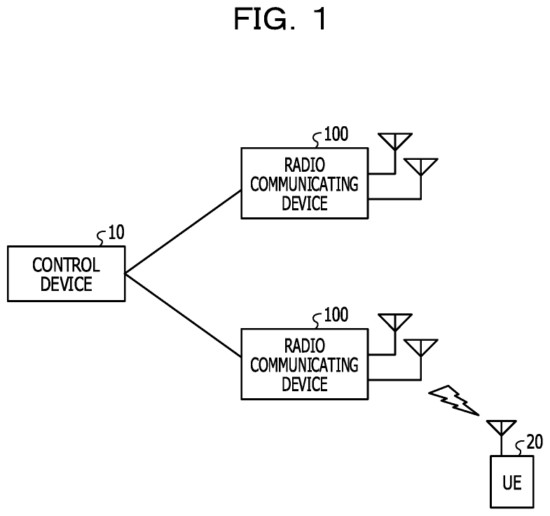

FIG. 1 is a diagram illustrating an example of a radio communication system according to the one embodiment. The radio communication system has a configuration in which a plurality of radio communicating devices 100 are coupled to a control device 10, and each of the radio communicating devices 100 performs radio communication with a terminal device (user equipment (UE)) 20.

The control device 10 is, for example, a central unit (CU) disposed in a server or the like, and coupled to a core network, which is not illustrated, or the like. The control device 10 controls radio communication by the plurality of radio communicating devices 100. For example, the control device 10 transmits a baseband signal addressed to the UE 20 to a radio communicating device 100 that may perform radio communication with the UE 20.

Each of the radio communicating devices 100 is a distributed unit (DU) arranged in a distributed manner and coupled to the control device 10 by wire. The radio communicating device 100 performs radio communication with the UE 20. For example, the radio communicating device 100 subjects a baseband signal received from the control device 10 to radio processing, and transmits a resulting radio signal to the UE 20. At this time, the radio communicating device 100, which includes a plurality of antenna elements, forms a beam with the stream of each antenna element provided with a phase difference, and performs directional transmission of the signal directed to the UE 20. In addition, the radio communicating device 100 performs calibration that estimates a phase rotation given to the stream in an analog circuit for each antenna element, and removes the estimated phase rotation from each stream. Incidentally, a concrete configuration and operation of the radio communicating device 100 will be described later in detail.

The UE 20 performs radio communication with the radio communicating device 100. For example, the UE 20 receives the radio signal transmitted from the radio communicating device 100 via an antenna. In addition, the UE 20 may generate a radio signal, and transmit the radio signal to the radio communicating device 100.

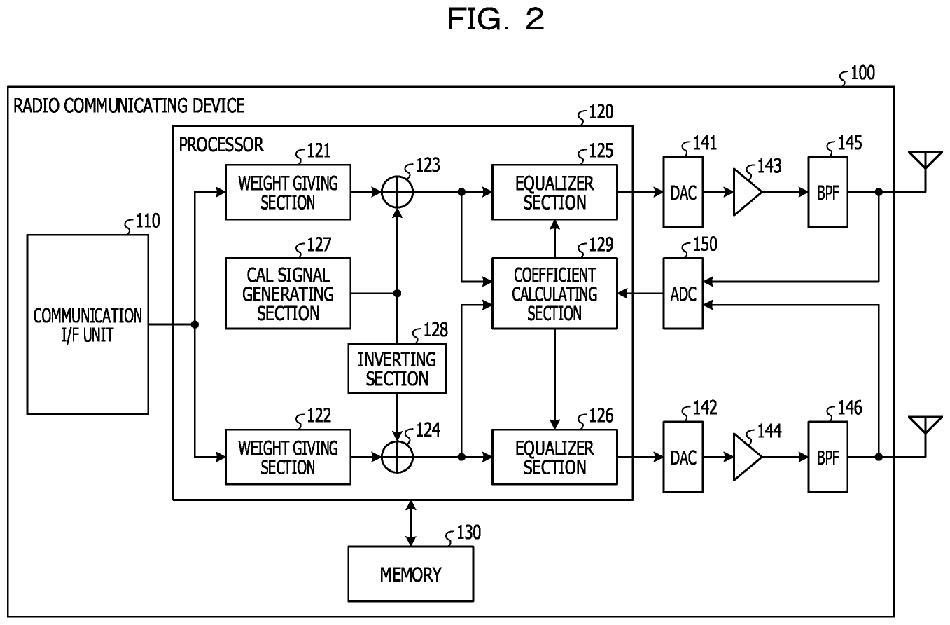

FIG. 2 is a block diagram illustrating a configuration of a radio communicating device according to the one embodiment. The radio communicating device illustrated in FIG. 2 may be the radio communicating device 100 illustrated in FIG. 1. The radio communicating device 100 illustrated in FIG. 2 includes a communication interface unit (hereinafter abbreviated as a “communication I/F unit”) 110, a processor 120, a memory 130, digital analog converters (DACs) 141 and 142, power amplifiers 143 and 144, band-pass filters (band pass filter (BPF)) 145 and 146, and an analog digital converter (ADC) 150. Incidentally, while the radio communicating device 100 in FIG. 2 includes two antenna elements, the radio communicating device 100 may have three or more antenna elements. In addition, in the following, a stream passing through an analog circuit of the power amplifier 143 and the BPF 145 or the like may be referred to as a “first stream,” and a stream passing through an analog circuit of the power amplifier 144 and the BPF 146 or the like may be referred to as a “second stream.”

The communication I/F unit 110 couples to the control device 10, and receives a baseband signal transmitted from the control device 10. The communication I/F unit 110 then inputs the baseband signal to the processor 120. Incidentally, the radio communicating device 100 includes a receiving unit that receives a signal from the UE 20, the receiving unit being omitted in FIG. 2, and the communication I/F unit 110 may transmit a received signal received by the receiving unit to the control device 10.

The processor 120, for example, includes a central processing unit (CPU), a field programmable gate array (FPGA), a digital signal processor (DSP), or the like. The processor 120 performs centralized control of the whole of the radio communicating device 100. For example, the processor 120 includes weight giving sections 121 and 122, adding sections 123 and 124, equalizer sections 125 and 126, a CAL signal generating section 127, an inverting section 128, and a coefficient calculating section 129.

The weight giving section 121 gives a weight for forming a beam to the baseband signal, and sets the resulting signal as a first stream.

The weight giving section 122 gives a weight for forming a beam to the baseband signal, and sets the resulting signal as a second stream.

The adding section 123 inserts a calibration signal (hereinafter abbreviated as a “CAL signal”) into the first stream. This CAL signal is a signal generated by the CAL signal generating section 127 to be described later.

The adding section 124 inserts the CAL signal into the second stream. This CAL signal is a signal generated by the inverting section 128 by inverting the phase of the CAL signal generated by the CAL signal generating section 127 to be described later.

The equalizer section 125 includes, for example, a finite impulse response (FIR) filter. The equalizer section 125 gives the first stream a phase rotation that cancels a phase rotation occurring in the analog circuit of the power amplifier 143 and the BPF 145 or the like. For example, the equalizer section 125 sequentially retains samples of an input signal in a plurality of delay devices, sums results obtained by multiplying the samples retained by the respective delay devices by coefficients, and outputs a resulting sum.

The equalizer section 126 includes, for example, an FIR filter. The equalizer section 126 gives the second stream a phase rotation that cancels a phase rotation occurring in the analog circuit of the power amplifier 144 and the BPF 146 or the like. For example, as with the equalizer section 125, the equalizer section 126 sequentially retains samples of the input signal in a plurality of delay devices, sums results obtained by multiplying the samples retained by the respective delay devices by equalizer coefficients (hereinafter referred to simply as “coefficients”), and outputs a resulting sum.

The CAL signal generating section 127 generates a given CAL signal in calibration execution timing that arrives in given cycles. The CAL signal generating section 127, for example, generates, as the CAL signal, a known signal that has a level lower by approximately 20 dB than the baseband signal as a main signal and is in a same frequency band as the baseband signal.

The inverting section 128 inverts the phase of the CAL signal generated by the CAL signal generating section 127, and outputs the CAL signal inverted in phase to the adding section 124. Incidentally, in this case, the radio communicating device 100 includes two antenna elements, and therefore the inverting section 128 inverts the phase of the CAL signal. However, in a case where the radio communicating device 100 includes three or more antenna elements, the phase and amplitude of CAL signals are adjusted such that the CAL signals corresponding to the respective three or more antenna elements cancel each other out. For example, the phase and amplitude of the CAL signals inserted into the respective streams are adjusted such that a sum total of the CAL signals corresponding to the respective antenna elements is zero.

In the calibration execution timing, the coefficient calculating section 129 calculates coefficients to be set in the equalizer sections 125 and 126 by using the input signals input to the equalizer sections 125 and 126 and feedback signals (hereinafter abbreviated as “FB signals”) output and fed back from the BPFs 145 and 146. For example, the coefficient calculating section 129 calculates the coefficient of the equalizer section 125 such that the phases of the input signal of the first stream input to the equalizer section 125 and the FB signal of the first stream output from the BPF 145 are made equal to each other. In addition, the coefficient calculating section 129 calculates the coefficient of the equalizer section 126 such that the phases of the input signal of the second stream input to the equalizer section 126 and the FB signal of the second stream output from the BPF 146 are equal to each other.

The coefficient calculating section 129 may perform the calculation of the coefficient of the equalizer section 125 and the calculation of the coefficient of the equalizer section 126 on a time-division basis during the calibration execution timing. In addition, because the coefficient calculating section 129 calculates the coefficients in the calibration execution timing, the input signals and the FB signals include the CAL signal. For example, when calibration is performed during signal transmission, the input signals and the FB signals including the baseband signal as the main signal and the CAL signal are input to the coefficient calculating section 129. When calibration is performed during other than signal transmission, on the other hand, the input signals and the FB signals including the CAL signal without including the main signal are input to the coefficient calculating section 129.

The memory 130, for example, includes a random access memory (RAM), a read only memory (ROM), or the like. The memory 130 stores information used for the processor 120 to perform processing.

The DAC 141 performs DA conversion of the first stream. The DA-converted first stream is up-converted to become a radio frequency signal.

The DAC 142 performs DA conversion of the second stream. The DA-converted second stream is up-converted to become a radio frequency signal.

The power amplifier 143 amplifies the first stream. The power amplifier 144 amplifies the second stream. The BPF 145 filters the first stream so as to pass a transmission frequency band through the BPF 145. The BPF 146 filters the second stream so as to pass a transmission frequency band through the BPF 146. The first stream and the second stream passed through the BPFs 145 and 146 are radio-transmitted from antenna elements. In the calibration execution timing, each stream includes the CAL signal. However, a sum total of these CAL signals is adjusted so as to be zero. Thus, the CAL signals radio-transmitted from the respective antenna elements are synthesized and cancel each other out, so that interference with the main signal may be reduced.

Incidentally, the analog circuits including the power amplifiers 143 and 144 and the BPFs 145 and 146 generate phase rotations in the first stream and the second stream, respectively. The phase rotations are canceled out when appropriate coefficients are set in the equalizer sections 125 and 126 by calibration.

In the calibration execution timing, the ADC 150 AD-converts the FB signal of the first stream output from the BPF 145 and the FB signal of the second stream output from the BPF 146, and inputs the AD-converted FB signal of the first stream and the AD-converted FB signal of the second stream to the coefficient calculating section 129 of the processor 120. The ADC 150 may perform the AD conversion of the FB signal of the first stream and the AD conversion of the FB signal of the second stream on a time-division basis during the calibration execution timing. In addition, because the ADC 150 performs the AD conversion in the calibration execution timing, the AD-converted FB signals include the CAL signal. For example, when calibration is performed during signal transmission, the FB signals including the main signal and the CAL signal are AD-converted. When calibration is performed during other than signal transmission, on the other hand, the FB signals including the CAL signal without including the main signal are AD-converted.

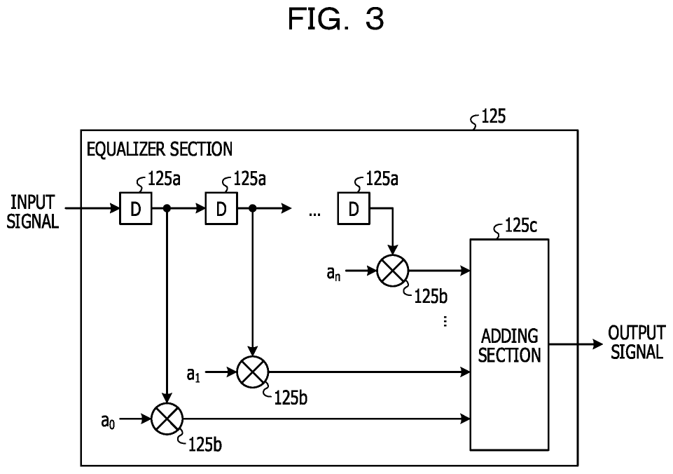

FIG. 3 is a block diagram illustrating a configuration of an equalizer section. The equalizer section illustrated in FIG. 3 may be the equalizer section 125 illustrated in FIG. 2. The equalizer section 126 has a configuration similar to that of the equalizer section 125 illustrated in FIG. 3. The equalizer section 125 illustrated in FIG. 3 includes a plurality of delay devices 125a, a plurality of multipliers 125b, and an adding section 125c.

The delay devices 125a each retain a sample of the input signal, and sequentially output the retained sample to the delay device 125a in a following stage and the multiplier 125b. The input signal whose samples are retained by the delay devices 125a is the first stream, and is a signal including the CAL signal in the calibration execution timing.

The multipliers 125b multiply the samples output from the delay devices 125a by coefficients a₀ to aₙ, respectively. These coefficients a₀ to aₙ are calculated by the coefficient calculating section 129 in the calibration execution timing.

The adding section 125c adds together results of multiplication of the respective multipliers 125b, and outputs a result obtained by the addition. When the coefficients a₀ to aₙ are set appropriately, the output signal from the adding section 125c is a signal given a phase rotation that cancels out a phase rotation occurring in the analog circuit of the power amplifier 143 and the BPF 145 or the like.

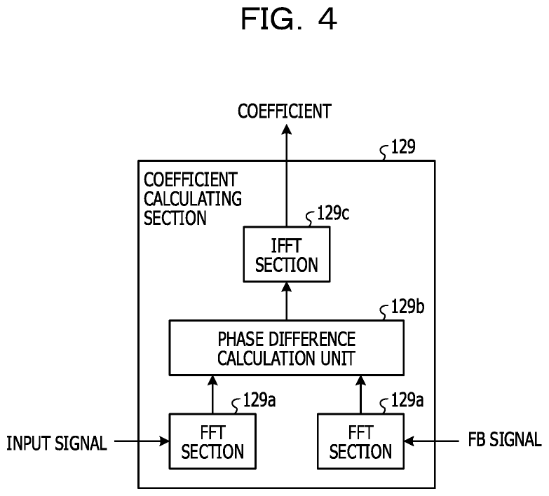

FIG. 4 is a block diagram illustrating a configuration of a coefficient calculating section. The coefficient calculating section illustrated in FIG. 4 may be the coefficient calculating section 129 illustrated in FIG. 2. The coefficient calculating section 129 illustrated in FIG. 4 includes fast Fourier transform (FFT) sections 129a, a phase difference calculating section 129b, and an inverse fast Fourier transform (IFFT) section 129c.

The FFT sections 129a each perform a fast Fourier transform of an input signal or an FB signal. For example, the FFT section 129a converts the input signal or the FB signal into a signal in a frequency domain. Incidentally, the input signal to the FFT section 129a is equivalent to the input signals to the equalizer sections 125 and 126, and is a signal including the CAL signal in the calibration execution timing. Similarly, the FB signal is the signals output and fed back from the BPFs 145 and 146, and is a signal including the CAL signal in the calibration execution timing. During the calibration execution timing, the input signals and the FB signals corresponding to the first stream and the second stream may be input to the FFT sections 129a on a time-division basis.

The phase difference calculating section 129b calculates a phase difference between the input signal and the FB signal after being converted into signals in the frequency domain. When there is no phase rotation in the analog circuits of the power amplifiers 143 and 144 and the BPFs 145 and 146 or the like, the input signal and the FB signal input to the coefficient calculating section 129 have the same phase. Thus, the phase difference calculated by the phase difference calculating section 129b corresponds to the phase rotations occurring in the analog circuits. Therefore, when the phase difference calculated by the phase difference calculating section 129b is set as the coefficients, and the streams are equalized in advance, the phase rotations occurring in the analog circuits are canceled out.

The IFFT section 129c performs an inverse fast Fourier transform of the phase difference calculated by the phase difference calculating section 129b. For example, the IFFT section 129c converts phase differences as the coefficients of the equalizer sections 125 and 126 into signals in a time domain. When the input signal and the FB signal of the first stream are input to the coefficient calculating section 129, the IFFT section 129c sets, in the equalizer section 125, the coefficient after being converted into the signal in the time domain. In addition, when the input signal and the FB signal of the second stream are input to the coefficient calculating section 129, the IFFT section 129c sets, in the equalizer section 126, the coefficient after being converted into the signal in the time domain.

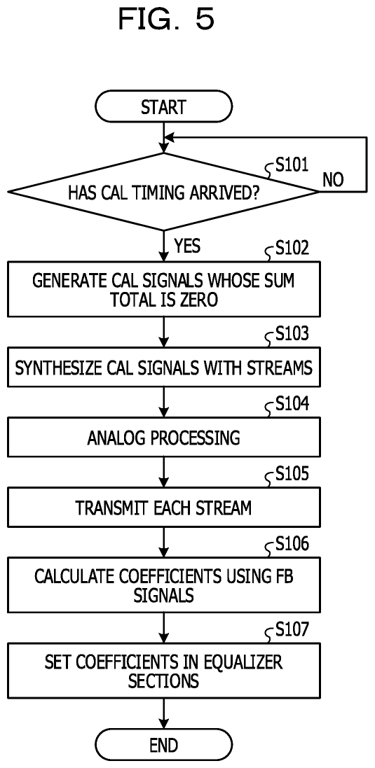

A calibration operation of the radio communicating device 100 configured as described above will next be described with reference to a flowchart illustrated in FIG. 5.

During operation of the radio communicating device 100, the CAL signal generating section 127 monitors whether or not the execution timing of calibration repeated in given cycles has arrived (step S101). The characteristics of the analog circuit for each antenna element change depending on an environment such as temperature or the like, and an amount of phase rotation occurring in the analog circuit also changes. The calibration execution timing may therefore be set to arrive in cycles of approximately one minute to a few minutes, for example. In addition, in a TDD system, for example, a gap time during which signal transmission is not performed nor is signal reception performed may be set as the calibration execution timing. However, calibration does not have to be completed within the gap time. For example, calibration may be performed at the same time as signal transmission. The following description will be continued supposing that calibration is performed at the same time as signal transmission.

When the calibration execution timing has arrived (Yes in step S101), the CAL signal generating section 127 generates the CAL signal. Then, the inverting section 128 inverts the phase of the CAL signal. Two CAL signals are thereby generated whose sum total is zero and which cancel each other out when synthesized (step S102). For example, because the radio communicating device 100 includes two antenna elements, the CAL signal generating section 127 and the inverting section 128 generate two CAL signals equal to each other in amplitude and opposite from each other in phase.

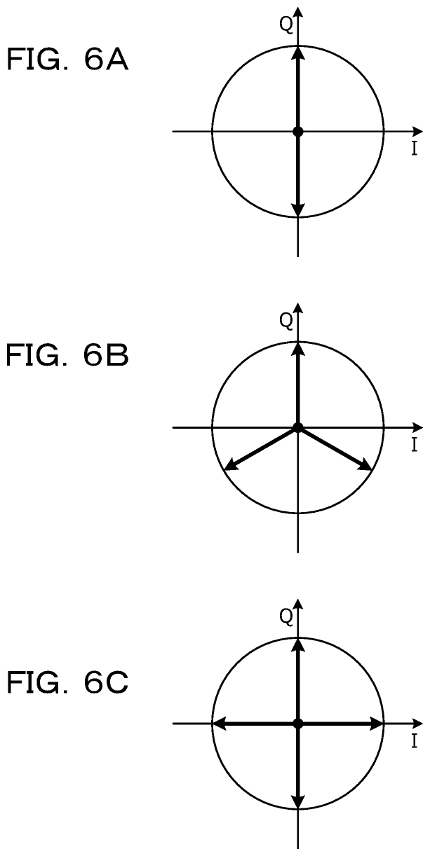

Incidentally, the number of antenna elements of the radio communicating device 100 is not limited to two. Thus, relation between the amplitudes and phases of the CAL signals corresponding to the respective antenna elements may not necessarily such that the CAL signals are equal to each other in amplitude and opposite from each other in phase as described above. Concrete examples of amplitudes and phases of CAL signals on an IQ plane are illustrated in FIGS. 6A to 6C.

In the case of two antenna elements, as illustrated in FIG. 6A, two CAL signals equal to each other in amplitude and opposite from each other in phase, for example, are generated. A sum total of these two CAL signals is zero. In addition, the frequency band of each CAL signal is the same as the frequency band of the baseband signal as the main signal.

In a case of three antenna elements, as illustrated in FIG. 6B, three CAL signals equal to each other in amplitude and different from each other in phase by 2π/3, for example, are generated. A sum total of these three CAL signals is zero. In the case of three antenna elements, in addition to the above, for example, the amplitude of two CAL signals may be set to ½ of the amplitude of the other CAL signal, and the two CAL signals of the smaller amplitude and the one signal of the larger amplitude may be set opposite from each other in phase. Also in this case, a sum total of the three CAL signals is zero, and the three CAL signals cancel each other out when synthesized.

In a case of four antenna elements, as illustrated in FIG. 6C, four CAL signals equal to each other in amplitude and different from each other in phase by π/2, for example, are generated. A sum total of these four CAL signals is zero. In the case of four antenna elements, in addition to the above, for example, two CAL signals equal to each other in amplitude and opposite from each other in phase may be supplied to each pair of two antenna elements. Also in this case, a sum total of the CAL signals supplied to the respective antenna elements is zero, and the CAL signals cancel each other out when synthesized.

As illustrated above, there are various combinations of the amplitudes and phases of the CAL signals that cancel each other out when synthesized. It is preferable that a sum total of the CAL signals of the respective antenna elements be zero with the CAL signals equal to each other in amplitude and different from each other only in phase. However, when there is an antenna element having a greater phase rotation generated in the analog circuit than that of the other antenna elements, for example, the amplitudes of the CAL signals supplied to the respective antenna elements may be made different from each other. For example, the amplitude of the CAL signal supplied to the antenna element having the greater phase rotation may be made smaller than the amplitudes of the CAL signals supplied to the other antenna elements. Consequently, when the streams are transmitted from the antenna elements, the levels of interference components originating from the phase rotations of the CAL signals may be reduced.

After the generation of the CAL signals that cancel each other out when synthesized, the CAL signals corresponding to the number of antenna elements, the CAL signals are synthesized with the streams corresponding to the respective antenna elements (step S103). For example, the CAL signal generated by the CAL signal generating section 127 is inserted into the first stream by the adding section 123, and the CAL signal inverted in phase by the inverting section 128 is inserted into the second stream by the adding section 124.

The streams in which the CAL signal is inserted respectively go through the equalizer sections 125 and 126 and are converted into analog signals by the DACs 141 and 142. The equalizer sections 125 and 126 give the respective streams phase rotations that cancel out phase rotations in the analog circuits according to the coefficients set in the equalizer sections 125 and 126. Here, description will be continued supposing that appropriate coefficients are not yet set in the equalizer sections 125 and 126, and that the phase rotations in the analog circuits are not canceled out.

The DA-converted streams are subjected to analog processing by the analog circuits for the respective antenna elements (step S104). For example, the first stream is up-converted to a radio frequency, amplified by the power amplifier 143, and then filtered by the BPF 145. Similarly, the second stream is up-converted to a radio frequency, amplified by the power amplifier 144, and then filtered by the BPF 146. In these pieces of analog processing, the streams are given phase rotations corresponding to the characteristics of the analog circuits. As described above, here, the coefficients of the equalizer sections 125 and 126 are not appropriate. Thus, being affected by these phase rotations, the phase differences of the first stream and the second stream are shifted from phase differences for forming a beam in a desired direction.

The streams output from the BPFs 145 and 146 are transmitted from the respective antenna elements (step S105). At this time, each stream includes the CAL signal. However, a sum total of the CAL signals for the respective antenna elements is adjusted to be zero. These CAL signals therefore cancel each other out, so that interference with the main signal is reduced. Hence, components other than the main signal radiated from the radio communicating device 100 to a radio section may be reduced to a minimum.

Incidentally, the streams output from the BPFs 145 and 146 are fed back and input to the ADC 150. Then, the ADC 150 AD-converts the fed-back FB signals, and outputs digital FB signals to the coefficient calculating section 129. At this time, the ADC 150 may AD-convert the respective FB signals of the first stream and the second stream in order on a time-division basis. In addition, in a case where the respective FB signals of the first stream and the second stream are AD-converted at the same time, the respective FB signals of the streams are output to the coefficient calculating section 129 separately from each other.

Then, the coefficient calculating section 129 calculates the coefficients of the equalizer sections 125 and 126, using the input signals of the respective streams input to the equalizer sections 125 and 126 and the FB signals of the respective streams, the FB signals being output from the ADC 150 (step S106). For example, the coefficient of the equalizer section 125 is calculated by performing a fast Fourier transform of each of the input signal and the FB signal of the first stream, and calculating a phase difference between the input signal and the FB signal. In addition, the coefficient of the equalizer section 126 is calculated by performing a fast Fourier transform of each of the input signal and the FB signal of the second stream, and calculating a phase difference between the input signal and the FB signal. These coefficients are coefficients that make the phases of the input signals and the FB signals of the respective streams equal to each other, and are coefficients that cancel out phase rotations in the analog circuits for the respective antenna elements.

Accordingly, coefficients calculated by the coefficient calculating section 129 are set in the respective equalizer sections 125 and 126 (step S107). Such calibration may be repeated until the coefficients set in the equalizer sections 125 and 126 converge. When the coefficients converge, the calibration is completed. Then, the effects of the phase rotations in the analog circuits for the respective antenna elements are removed by completing the calibration and setting appropriate coefficients in the equalizer sections 125 and 126. As a result, the phase differences of the first stream and the second stream reflect the weights given by the weight giving sections 121 and 122, and a beam is formed in a desired direction.

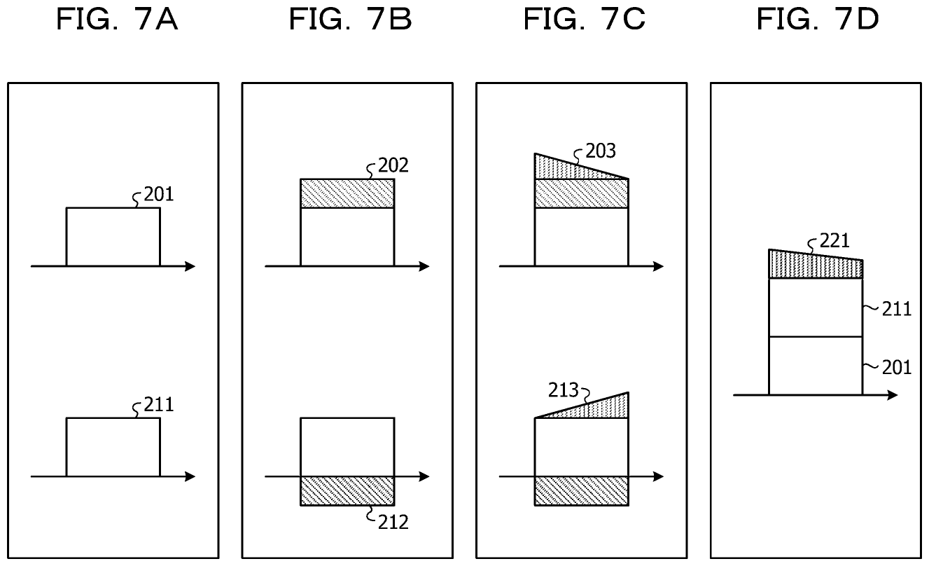

Next, transitions of the streams during calibration operation will be described by citing a concrete example. FIGS. 7A to 7D are diagrams illustrating concrete examples of transitions of streams during calibration operation. FIGS. 7A to 7D illustrate transitions in a case where calibration is performed at the same time as signal transmission.

As illustrated in FIG. 7A, when a baseband signal is input to the weight giving sections 121 and 122, weights for forming a beam are given to the baseband signal, and the baseband signal becomes the main signals of the respective streams. For example, the first stream includes a main signal 201, and the second stream includes a main signal 211.

The adding sections 123 and 124 synthesize these streams with CAL signals. For example, as illustrated in FIG. 7B, CAL signals 202 and 212 opposite from each other in phase are inserted into the first stream and the second stream, respectively. In FIG. 7B, the CAL signal 202 has a positive phase, and the CAL signal 212 has a negative phase obtained by inverting the phase of the CAL signal 202.

The streams synthesized with the CAL signals go through the equalizer sections 125 and 126, are converted into analog signals, and are then subjected to analog processing by the analog circuits of the power amplifiers 143 and 144 and the BPFs 145 and 146 or the like. The analog circuits cause phase rotations corresponding to characteristics. Thus, as illustrated in FIG. 7C, the first stream is given a phase rotation 203, and the second stream is given a phase rotation 213. These phase rotations 203 and 213 differ for the respective analog circuits for the respective antenna elements. Therefore, the weights given to the respective streams for beam formation are not properly reflected, and the direction of the beam is shifted from a desired direction. Accordingly, appropriate coefficients of the equalizer sections 125 and 126 are calculated by the above-described calibration operation using the CAL signals 202 and 212.

The streams after being subjected to the analog processing are respectively transmitted from the corresponding antenna elements. The streams transmitted from the antenna element are synthesized in a radio section. At this time, as illustrated in FIG. 7D, the synthesized signal includes the main signals 201 and 211 and a phase rotation 221. For example, because a sum total of the CAL signals 202 and 212 is adjusted to be zero, the CAL signals 202 and 212 cancel each other out in the radio section, so that interference with the main signals 201 and 211 may be reduced. In addition, the phase rotation 221 results from synthesis of the phase rotations 203 and 213 of the respective streams. However, when appropriate coefficients are set in the equalizer sections 125 and 126 by the calibration, the effects of the phase rotations 203 and 213 are removed, and the effect of the phase rotation 221 is also reduced.

As described above, according to the present embodiment, calibration signals for the respective antenna elements are generated so as to cancel each other out when synthesized, and the calibration signals are inserted into the streams for the respective antenna elements. Then, the streams are fed back, and coefficients that cancel out phase rotations occurring in the analog circuits for the respective antenna elements are calculated and set in the equalizer sections for the respective antenna elements. Therefore, when the streams are transmitted from the antenna elements, the calibration signals cancel each other out, so that interference with the main signals of the respective streams may be reduced. For example, calibration between a plurality of antenna elements may be performed even during signal transmission.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A radio communication device comprising:
a plurality of analog circuits, each of the plurality of analog circuits being configured to be associated with one of a plurality of antenna elements, subject a stream of the associated antenna element to analog processing, and transmit the stream from the associated antenna element; and
a processor configured to
execute a generating process that includes generating calibration signals, the calibration signals being calibration signals equal in number to the plurality of antenna elements and being configured to cancel each other out when synthesized,
execute a synthesizing process that includes synthesizing the calibration signals with the respective streams of the plurality of antenna elements, and
execute a calculating process that includes calculating an equalizer coefficient based on the stream and a first feedback signal, the first feedback signal being a stream feedback signal fed back from each of the plurality of analog circuits, the equalizer coefficient being a coefficient for removing a phase rotation occurring in each of the plurality of analog circuits.

2. The radio communication device according to claim 1,
wherein the processor is further configured to execute an equalizer process that includes removing the phase rotation by using the equalizer coefficient.

3. The radio communication device according to claim 1,
wherein the calculating process is configured to calculate the equalizer coefficient by using a phase difference between the stream and the stream feedback signal.

4. The radio communication device according to claim 1,
wherein the generating process is configured to generate two calibration signals equal to each other in amplitude and opposite from each other in phase in a case in which the plurality of antenna elements are two antenna elements.

5. A method for calibration performed by a radio communication device, the radio communication device including a processor and a plurality of analog circuits, each of the plurality of analog circuits being configured to be associated with one of a plurality of antenna elements, subject a stream of the associated antenna element to analog processing, and transmit the stream from the associated antenna element, the method comprising:
executing a generating process that includes generating calibration signals, the calibration signals being calibration signals equal in number to the plurality of antenna elements and being configured to cancel each other out when synthesized;
executing a synthesizing process that includes synthesizing the calibration signals with the respective streams of the plurality of antenna elements; and
executing a calculating process that includes calculating an equalizer coefficient based on the stream and a first feedback signal, the first feedback signal being a stream feedback signal fed back from each of the plurality of analog circuits, the equalizer coefficient being a coefficient for removing a phase rotation occurring in each of the plurality of analog circuits.

6. The method according to claim 5,
wherein the processor is further configured to execute an equalizer process that includes removing the phase rotation by using the equalizer coefficient.

7. The method according to claim 5,
wherein the calculating process is configured to calculate the equalizer coefficient by using a phase difference between the stream and the stream feedback signal.

8. The method according to claim 5,
wherein the generating process is configured to generate two calibration signals equal to each other in amplitude and opposite from each other in phase in a case in which the plurality of antenna elements are two antenna elements.
